(19) United States
(12) Patent Application Publication
(10) Pub. No.: US 2025/0211553 A1
(43) Pub. Date: Jun. 26, 2025

(54) METHOD AND APPARATUS FOR INSTANT MESSAGING SERVICE

(71) Applicant: KAKAO CORP., Jeju-si (KR)

(72) Inventors: Won Bom HONG, Seongnam-si (KR); Jung Eun PARK, Seongnam-si (KR); Ga Hye JEON, Seongnam-si (KR); Hye Jin JUNG, Seongnam-si (KR); Bo Ra YOON, Seongnam-si (KR); Yi Kyong LIM, Seongnam-si (KR); Ji Sun PARK, Seongnam-si (KR)

(21) Appl. No.: 19/000,397

(22) Filed: Dec. 23, 2024

(30) Foreign Application Priority Data
Dec. 26, 2023 (KR) 10-2023-0191718

(51) Int. Cl. H04L 51/046; H04W 68/00

(52) U.S. Cl. CPC H04L 51/046; H04W 68/00

(57) ABSTRACT

Disclosed is a method and apparatus for an instant messaging service. An operating method of a server providing an instant messaging service includes extracting information on a channel to which a notification message corresponding to a user account is transmitted, determining a type of notification message based on metadata of the notification message, generating a news feed corresponding to the notification message based on the type of the notification message, and providing an aggregation page of the news feed linked to a chatroom of the channel to a terminal of the user account.

### CROSS-REFERENCE TO RELATED APPLICATION(S)

This application claims the priority benefit of Korean Patent Application No. 10-2023-0191718 filed on Dec. 26, 2023, in the Korean Intellectual Property Office, the disclosure of which is incorporated herein by reference for all purposes.

### BACKGROUND

### 1. Field

One or more embodiments relate to a method and apparatus for an instant messaging service.

### 2. Description of the Related Art

The advancement in mobile smart devices has increased the use of online platform services for interaction with other users over a network. The online platform services for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. With the increase in communication via mobile devices, online platform services are developing communication technologies to provide various types of information as well as one-on-one communication with other users.

### SUMMARY

One or more embodiments provide a technique for generating a news feed corresponding to a notification message and aggregating the news feed to provide to a user.

However, technical aspects are not limited to the foregoing aspects, and there may be other technical aspects.

An operating method of a server providing an instant messaging service (IMS) according to an embodiment includes extracting information on a channel to which a notification message corresponding to a user account is transmitted, determining a type of the notification message based on metadata of the notification message, generating a news feed corresponding to the notification message based on the type of the notification message, and providing an aggregation page of the news feed linked to a chatroom of the channel to a terminal of the user account.

The generating of the news feed corresponding to the notification message may include determining a data type to be extracted for the generating of the news feed based on the type of the notification message, extracting target data corresponding to the determined data type from the metadata of the notification message, and generating the news feed including the target data.

The determining of the type of the notification message may include determining the type of the notification message based on metadata related to a template of the notification message.

The generating of the news feed corresponding to the notification message may include generating a news feed including status information of progress corresponding to the notification message determined to be a progress type.

The generating of the news feed corresponding to the notification message may include generating a news feed including cumulative aggregate information of an item corresponding to the notification message determined to be a cumulative aggregate type.

The operating method of the server may further include providing a page of a chatroom of a channel including the notification message, based on a request to retrieve the notification message corresponding to the news feed.

The providing of the aggregation page of the news feed may include providing the aggregation page of the news feed based on whether the notification message has been confirmed of receipt.

The providing of the aggregation page of the news feed may include providing the aggregation page of the news feed based on whether the notification message has been stored. The providing of the aggregation page of the news feed may include providing the aggregation page of the news feed based on the importance of the notification message.

The operating method of the server may further include generating schedule information corresponding to metadata related to a schedule included in the notification message.

The news feed may include information on the channel from which the notification message is transmitted.

The news feed may include information on an interfacing object included in the notification message.

An operating method of a terminal running an instant messenger according to an embodiment includes displaying an aggregation page of a news feed corresponding to a notification message transmitted through a channel, receiving a request to retrieve a target notification message corresponding to a target news feed, based on the target news feed included in the aggregation page, and displaying a page of a chatroom of a target channel including the target notification message.

The aggregation page of the news feed may include at least one of a list of news feeds aggregated by channel and a list of news feeds aggregated by type.

The operating method of the terminal may further include requesting generation of a schedule corresponding to the notification message, and displaying a schedule generation page in which metadata extracted from the notification message is input as a parameter.

A server providing an IMS according to an embodiment includes one or more processors configured to extract information on a channel to which a notification message corresponding to a user account is transmitted, determine a type of the notification message based on metadata of the notification message, generate a news feed corresponding to the notification message based on the type of the notification message, and provide an aggregation page of the news feed linked to a chatroom of the channel to a terminal of the user account.

The one or more processors may, for the generating of the news feed corresponding to the notification message, determine a data type to be extracted for the generating of the news feed based on the type of the notification message, extract target data corresponding to the determined data type from the metadata of the notification message, and generate the news feed including the target data.

The one or more processors may, for the determining of the type of the notification message, determine the type of the notification message based on metadata related to a template of the notification message.

A terminal running an instant messenger according to an embodiment includes one or more processors configured to display an aggregation page of a news feed corresponding to a notification message transmitted through a channel, receive a request to retrieve a target notification message corresponding to a target news feed, based on the target news feed included in the aggregation page, and display a page of a chatroom of a target channel including the target notification message.

### BRIEF DESCRIPTION OF THE DRAWINGS

FIG. 1 is a diagram illustrating a system for an instant messaging service (IMS) according to an embodiment.

FIG. 2 is a flowchart of an operation of a server providing the IMS according to an embodiment.

FIG. 3 is a diagram illustrating a template of a notification message according to an embodiment.

FIGS. 4A to 4E are diagrams illustrating a screen of a terminal displaying an aggregation page of a news feed according to an embodiment.

FIG. 5 is a diagram illustrating a storage function of a notification message according to an embodiment.

FIGS. 6A and 6B are diagrams illustrating a screen of a terminal displaying an aggregation page of a news feed according to an embodiment.

FIG. 7 is a flowchart of an operation of a terminal running an instant messenger according to an embodiment.

FIGS. 8A to 8C are diagrams illustrating an operation of a terminal running an instant messenger according to an embodiment.

FIGS. 9A to 9E are diagrams illustrating entry points within an instant messenger for entering an aggregation page of a news feed according to an embodiment.

FIGS. 10A and 10B are diagrams illustrating a schedule generation function corresponding to a notification message according to an embodiment.

FIG. 11 is a diagram illustrating a hardware configuration of a system for the IMS according to an embodiment.

### DETAILED DESCRIPTION

The following detailed structural or functional description is provided as an example only and various alterations and modifications may be made to embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

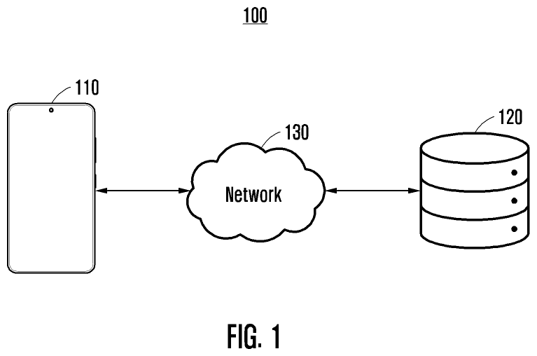

FIG. 1 is a diagram illustrating a system for an instant messaging service (IMS) according to an embodiment.

Referring to FIG. 1, a system 100 for an IMS according to an embodiment may include a terminal 110, a server 120, and a network 130. The detailed hardware configurations of the server 120 and the terminal 110 are described in detail below.

The server 120 may include a server providing an IMS through the network 130. The IMS may include a service allowing a plurality of users to chat in real time by transmitting text messages, voice messages, media files, and other instant messages through the network 130, such as wireless Internet or a wireless communication network, and services related thereto. For example, the server 120 may include a server providing an IMS for notification messages transmitted through a channel. The IMS for notification messages transmitted through a channel is described in detail below.

The server 120 may be linked with a web related to the IMS or an application (hereinafter, “app”) related to the IMS executed by the terminal 110 to provide a user interface (UI), a function, an operation, a service, or the like. Hereinafter, a web related to the IMS or an app related to the IMS may be referred to as an instant messenger.

The terminal 110 may be one of electronic devices such as a computer, a portable computer, a wireless phone, a mobile phone, a smartphone, a personal digital assistant (PDA), a web tablet, a wearable device, and the like, and may refer to any device that may install and execute an app or execute a web. In this case, the terminal 110 may be provided with services and/or content through an app or a web. For example, under the control of an app or a web, the terminal 110 may perform overall service operations, such as service screen setting, data input, data transmission and reception, and data storage. For example, the terminal 110 may process a user interface or user interaction through a processor, and output or transmit a result of the processing through an output device of the terminal 110.

An instant messenger provided by the server 120 may drive the terminal 110. A user may use the IMS provided by the server 120 by executing the instant messenger in the terminal 110. The user may create a user account by subscribing to the IMS through the instant messenger. The user may use the IMS through the terminal 110 of the account subscribed to the IMS. The terminal 110 of the account subscribed to the IMS may be a terminal logged into an account subscribed to the IMS.

According to an embodiment, a chat interface may be provided to the terminal 110 through an app for the IMS. The chat interface may be an interface for a message transmission/reception function related to the IMS and may include, for example, an interface providing a function of transmitting messages through a chatroom, in which at least one user account participates, and displaying the received messages. The chat interface may correspond to a chatroom, which is a virtual space in which at least one user account participates and a chat between users takes place.

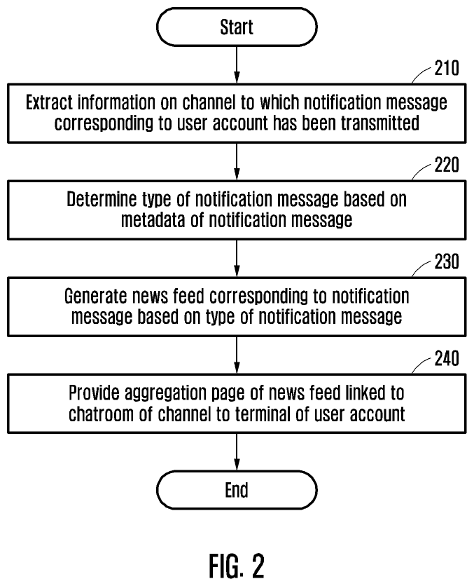

FIG. 2 is a flowchart of an operation of a server providing an IMS according to an embodiment.

An operating method of a server according to an embodiment may include an operation 210 of extracting information on a channel to which a notification message corresponding to a user account has been transmitted.

An instant messaging server may provide various types of accounts for the use of the IMS, such as personal accounts, corporate accounts, or service accounts. The personal accounts may be accounts for general users, the corporate accounts may be accounts for particular companies, and the service accounts may be accounts for particular services. The corporate account or the service account may be referred to as a channel.

For example, the information on the channel may include chatroom information of the channel to which the notification message has been transmitted. A notification message may be a type of message that may be transmitted through a chatroom of a channel. For example, a notification message may be transmitted through a chatroom of a channel to a terminal of a user account that has not registered the channel as an account of a particular relationship. The server may extract chatroom information of the channel to which the notification message is transmitted among chatrooms including the user account.

The operating method of the server according to an embodiment may include an operation 220 of determining a type of a notification message based on metadata of the notification message.

The type of the notification message may be intended to classify notification messages according to content, purpose, or status of the notification message, and may include, for example, at least one of a progress type, a cumulative aggregate type, and a reservation type.

The progress type notification message may be a type of notification message that is transmitted at each predetermined series of statuses. For example, a notification message regarding the shipment of a product may correspond to the progress type notification message that is transmitted for each series of statuses, including an order completion status, a product shipment status, an in-transit status, and a delivery completion status.

The cumulative aggregate type may be a type of notification message that is transmitted to notify of a cumulative aggregate sum of data as the data changes. For example, a notification message regarding point accumulation may be a cumulative aggregate type notification message that notifies the cumulative aggregate sum of points due to a point accumulation or point use event when the event occurs. For example, a notification message regarding credit card usage may be a cumulative aggregate type notification message that notifies the cumulative aggregate sum of credit card usage amounts due to an event of credit card usage or payment of credit card usage amounts when the event occurs.

The reservation type may be a type of notification message to inform reservation information. For example, a notification message regarding a reservation for a particular product, service, or location may be a reservation-type notification message that provides information on a reservation time and a reservation location. For example, a notification message regarding a ticket (e.g., a movie ticket, admission ticket, airline ticket, and the like) reservation may correspond to a reservation-type notification message that provides at least one of information on a reservation target, information on a reservation time, and information on a location for using a reserved ticket.

According to an embodiment, the operation 220 of determining the type of the notification message may include determining the type of the notification message based on metadata regarding a template of the notification message. A notification message may be generated based on a predetermined template. The template may include at least one field and a predetermined text. The field may be a particular type of data into which a user may input a value, such as a business name field, a purpose of visit field, a sending time field, and a points field. The metadata regarding the template of the notification message may be structured data regarding the template of the notification message, which may include, for example, a field included in the template of the notification message. For example, a type of notification message may be determined based on the type of data included in the metadata regarding the template of the notification message. More specifically, the type of notification message may be determined by the type of field included in the template of the notification message.

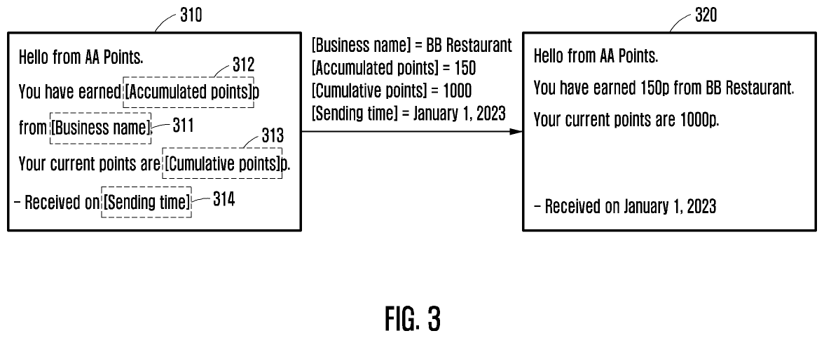

For example, referring to FIG. 3, a template 310 of a notification message may include a business name field 311, an accumulated points field 312, a cumulative points field 313, and a sending time field 314, and may be determined to include a predetermined text. A notification message 320 generated based on the template 310 may include text included in the template 310 and values of the fields 311, 312, 313, and 314 determined corresponding to the notification message 320. For example, a value of the business name field 311 may be determined to be “BB Restaurant”, a value of the accumulated points field 312 may be determined to be “150”, a value of the cumulative points field 313 may be determined to be “1000”, and a value of the sending time field 314 may be determined to be “Jan. 1, 2023”, so that the notification message 320 based on the template 310 may be generated. The values of the fields 311, 312, 313, and 314 included in the template 310 may be determined by a sender of the notification message.

The type of a notification message may be determined based on the type of the field or a value of the field included in the template of the notification message. For example, when a template of a notification message includes a progress field to which a value indicating a predetermined status is input, the notification message may be determined to be the progress type. For example, when the template of a notification message includes an accumulated points field or a cumulative amount field, the notification message may be determined to be the cumulative aggregate type. For example, when the template of a notification message includes at least one of a reservation time field, a reservation location field, and a reservation target field, the notification message may be determined to be the reservation type.

In an embodiment, the notification message may include a classification tag. The classification tag may include a value for determining the type of the notification message. Based on the value of the classification tag, the type of the notification message may be determined. For example, the value of a classification tag may include at least one of a value indicating a progress type, a value indicating a cumulative aggregate type, and a value indicating a reservation type. For example, the value of a classification tag may include at least one of an “order/delivery” value corresponding to the progress type, a “payment” value corresponding to the cumulative aggregate type, and a “reservation/booking” value corresponding to the reservation type. In addition, the value of a classification tag may include various values for classifying the notification message. For example, the classification tag may be a detailed type of the notification message. The types of notification messages, including the progress type, the cumulative aggregate type, and the reservation type, may include one or more classification tags belonging to the corresponding type. For example, a first classification tag and a second classification tag may belong to the progress type, that is, a notification message including the first classification tag and a notification message including the second classification tag may be classified as the progress type.

The operating method of the server according to an embodiment may include an operation 230 of generating a news feed corresponding to a notification message based on a type of the notification message. The news feed corresponding to the notification message may include at least a portion of the information included in the notification message and/or information describing the content of the notification message.

According to an embodiment, the operation 230 of generating the news feed corresponding to the notification message may include determining a data type to be extracted for generating the news feed based on the type of the notification message, extracting target data corresponding to the data type determined from metadata of the notification message, and generating a news feed including the target data.

For example, the operation 230 of generating the news feed corresponding to the notification message may include generating a news feed including status information of a progress corresponding to a notification message determined to be the progress type. When the type of the notification message is the progress type, data corresponding to the type of the status information in the metadata of the notification message may be extracted as the target data. A news feed corresponding to the notification message of the progress type may include target data of the type of the status information.

For example, the operation 230 of generating the news feed corresponding to the notification message may include generating a news feed including cumulative aggregate information of an item corresponding to a notification message determined to be the cumulative aggregate type. When the type of the notification message is the cumulative aggregate type, data corresponding to the type of the cumulative aggregate information of the item in the metadata of the notification message may be extracted as the target data. A news feed corresponding to the notification message of the cumulative aggregate type may include target data of the type of the cumulative aggregate information of the item. The item may be an object of cumulative aggregation and may include, for example, points, spending amounts, coupons, and bank account balances.

For example, when the type of the notification message is the reservation type, data corresponding to at least one type of reservation time, reservation location, and reservation target may be extracted as target data from the metadata of the notification message. A news feed corresponding to the notification message of the reservation type may include target data of at least one type of reservation time, reservation location, and reservation target.

According to an embodiment, the operating method of the server may include providing a page of a chatroom of a channel including a notification message, based on a request to retrieve a notification message corresponding to a news feed. For example, the chatroom of the channel including the notification message may include a chatroom of the channel where the notification message is located. A terminal of a user account may request to retrieve the notification message corresponding to the news feed through the news feed. When the request to retrieve the notification message is received, the server may provide a page of the chatroom of the channel where the corresponding notification message may be viewed to the terminal of the user account. The terminal of the user account may access the page of the chatroom of the channel through the news feed, where the notification message corresponding to the news feed is displayed in the chatroom of the channel.

In an embodiment, the news feed may include information on a channel transmitting a notification message. For example, the news feed may include a link to a chatroom of a channel. For example, the news feed may include a link to the location of a notification message corresponding to a news feed in a chatroom of a channel. The terminal of the user account may access a location in the chatroom of the channel where the notification message corresponding to the news feed is displayed through the link included in the news feed.

When the chatroom of the channel is accessed directly from the terminal, a page displaying a message received first among messages that have not been confirmed of receipt or a page displaying the most recently received message may be provided. When the chatroom of the channel is accessed from the terminal through the news feed corresponding to the notification message, a chatroom page of the channel displaying the notification message corresponding to the news feed may be provided.

In an embodiment, the news feed may include information on an interfacing object included in the notification message. The notification message may include an interfacing object that provides detailed information on the notification message or performs a process corresponding to the notification message. The interfacing object may be an object implemented to perform particular functions through interaction with the user and may include, for example, a button, an input window, a display window, a picker, and the like. For example, the interfacing object may include a link to a page regarding a notification message. For example, the interfacing object may include a link to a page providing information on the notification message. For example, the interfacing object may include a function for calling an application programming interface (API) to perform a process corresponding to the notification message.

The news feed may include at least a portion of the interfacing objects included in the notification message. For example, when the notification message includes a button in which a link to a predetermined page is implemented, the news feed corresponding to the notification message may include the corresponding button. When an input for selecting the button included in the news feed is received through the terminal, the predetermined page may be provided to the terminal. For example, when the notification message includes a button in which a function for calling a predetermined API is implemented, the news feed corresponding to the notification message may include the corresponding button. When an input for selecting the button included in the news feed is received through the terminal, the predetermined API may be called and executed in the terminal.

The operating method of the server according to an embodiment may include an operation 240 of providing an aggregation page of a news feed linked to a chatroom of a channel to a terminal of a user account. The aggregation page of the news feed may include a list of a plurality of news feeds, each corresponding to a notification message.

The operation 240 of providing the aggregation page of the news feed according to an embodiment may include providing the aggregation page of the news feed based on whether a notification message has been confirmed of receipt.

The operation 240 of providing the aggregation page of the news feed according to an embodiment may include providing the aggregation page of the news feed based on whether a notification message is stored. The aggregation page of the news feed may include a list of news feed(s) corresponding to notification messages stored by the user account.

The operation 240 of providing the aggregation page of the news feed according to an embodiment may include providing the aggregation page of the news feed based on the importance of a notification message. For example, the aggregation page of the news feed may include a list of news feed(s) corresponding to notification messages determined to be of high importance. For example, the aggregation page of the news feed may include a list of news feed(s) sorted in order of importance of the notification message.

For example, the importance of the news feed may be determined based on whether the notification message has been confirmed of receipt. The importance of a news feed corresponding to a notification message that has not been confirmed of receipt may be determined to be higher than the importance of a news feed corresponding to a notification message that has been confirmed of receipt.

For example, the importance of the news feed may be determined based on the relevance of the notification message to the current time. For example, when a reservation date included in a notification message for notifying reservation information corresponds to a date of the current time, or an expiration date included in a notification message for notifying the expiration of a particular event (e.g., a reservation, points, coupons, and the like) corresponds to a date of the current time, the importance of the news feed corresponding to the notification message may be determined to be higher than the importance of a news feed corresponding to other notification messages.

For example, the importance of the news feed may be determined based on the channel through which a notification message is transmitted. For example, when the channel transmitting the notification message is a channel of an institution, company, or service included in a whitelist, such as a government agency, public agency, or hospital, the importance of the news feed corresponding to the notification message may be determined to be higher than the importance of a news feed corresponding to a notification message transmitted from another channel. For example, the importance of the news feed corresponding to the notification message that is determined to be of high importance by the channel transmitting the notification message may be determined to be higher than the importance of a news feed corresponding to a notification message that is determined not to be of high importance.

On the aggregation page of a news feed, the news feeds may be sorted according to predetermined criteria. For example, the news feeds may be sorted in ascending or descending order of the time when a notification message is transmitted. For example, the news feeds may be sorted in ascending or descending order of importance.

The operating method of the server according to an embodiment may include generating schedule information corresponding to metadata regarding a schedule included in a notification message. The metadata regarding the schedule may include at least one of a date, time, and location. The metadata regarding the schedule may be extracted from the notification message, and an interface for generating and registering schedule information corresponding to the extracted metadata may be provided. The generating of the schedule information corresponding to the notification message is described in detail below.

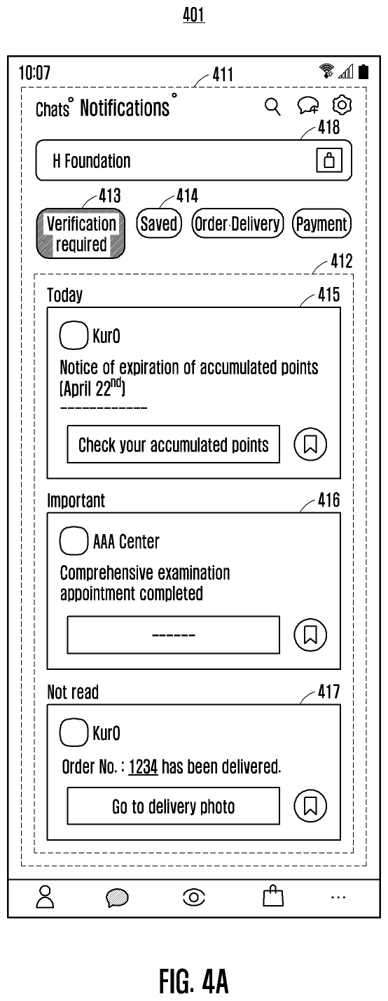

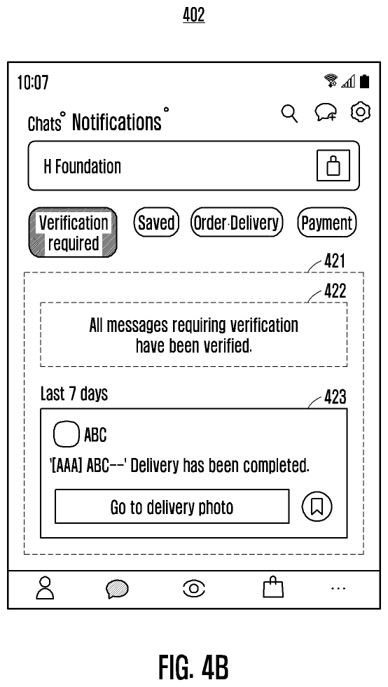

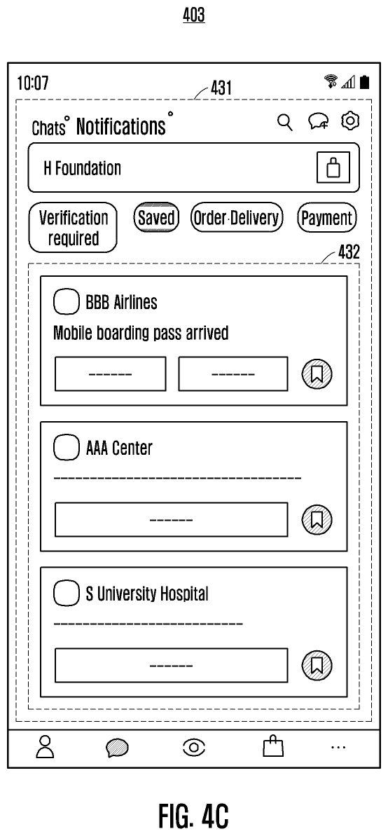

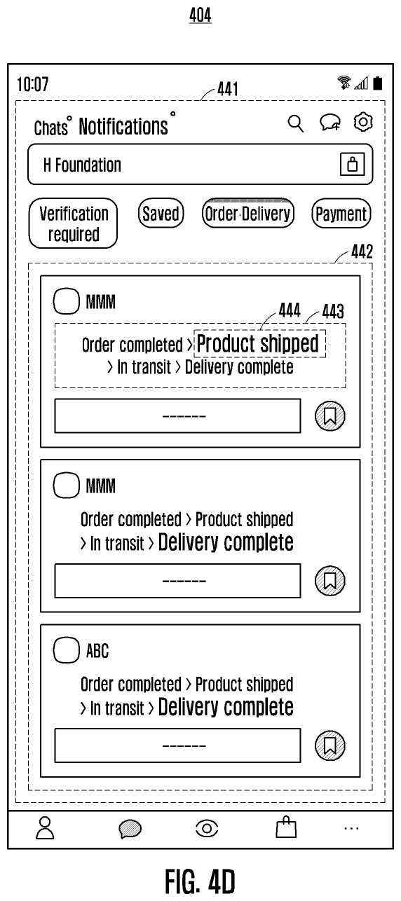

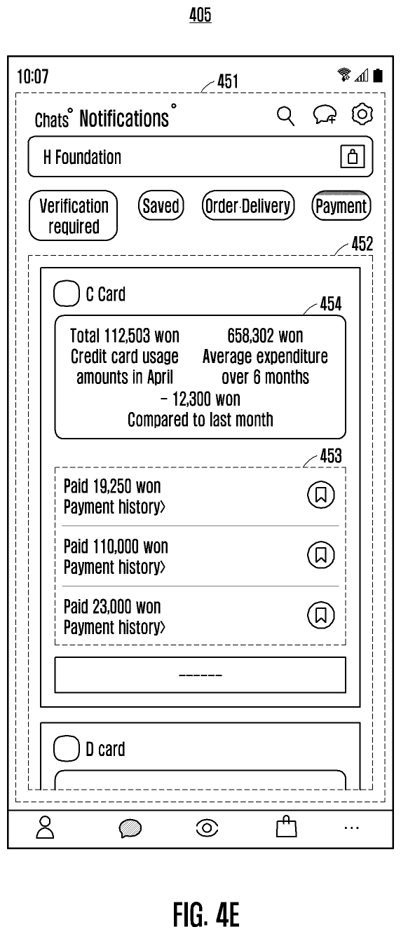

FIGS. 4A to 4E are diagrams illustrating a screen of a terminal displaying an aggregation page of a news feed according to an embodiment.

An aggregation page of a news feed may be provided to a terminal running an instant messenger linked to a server providing an IMS. The terminal may be the terminal 110 of FIG. 1. The terminal may include a terminal logged in with a user account subscribed to an IMS provided by the server. Hereinafter, the user account may be a user account logged into the terminal.

For example, the aggregation page of the news feed may include a list of news feeds aggregated by type. A type may include a type of notification message and/or a detailed type of a notification message. The aggregation page of the news feed may include one or more lists of news feeds corresponding to each type. The list of each news feed may include one or more news feeds corresponding to a particular type of notification message.

For example, referring to a screen 401 of FIG. 4A, an aggregation page 411 of the news feed may include a list of news feeds by type. The aggregation page 411 of the news feed may include a list 412 of news feeds of a “verification required” type, a list of news feeds of a “saved” type, a list of news feeds of an “order/delivery” type, a list of news feeds of a “payment” type, and a list of news feeds of a “coupons/points” type. The types illustrated in FIG. 4A are only examples of types for distinguishing the list of news feeds, and the types for distinguishing the list of news feeds are not limited to the examples illustrated in FIG. 4A.

As illustrated in FIG. 4A, when an input for selecting a button 413 of the “verification required” type is received by the terminal, the list 412 of news feeds of the “verification required” type may be displayed on the terminal. When an input for selecting a button 414 of the “saved” type is received, the list 412 of news feeds displayed on the aggregation page 411 of the news feed may be changed to a list of news feeds of the “saved” type.

The list 412 of news feeds of the “verification required” type may be a list of feed(s) corresponding to a notification message determined to be of high importance.

The list 412 of news feeds of the “verification required” type may include a news feed corresponding to a notification message relevant to the current time. For example, a news feed 415 corresponding to the notification message relevant to the current time may be a news feed corresponding to a notification message that includes a date of the current time as an expiration date of accumulated points. Information on the expiration date of the accumulated points included in the notification message may be extracted based on template information of the notification message. For example, when a template of the notification message includes an expiration date field, the information on the expiration date may be obtained by extracting an expiration date field value.

The list 412 of news feeds of the “verification required” type may include a news feed 416 corresponding to a notification message transmitted from a channel of an institution, company, or service included in the whitelist.

The list 412 of news feeds of the “verification required” type may include a news feed 417 corresponding to a notification message that has not been confirmed of receipt.

In an embodiment, an advertisement may be provided through a predetermined area 418 in the aggregation page 411 of the news feed. For example, the advertisement may include an advertisement related to a news feed included in the aggregation page 411 of the news feed. The advertisement may include the content of a notification message corresponding to the news feed included in the aggregation page 411 of the news feed and/or an advertisement related to the channel that transmits the notification message.

For example, referring to a screen 402 of FIG. 4B, when a news feed corresponding to a notification message determined to be of high importance is no longer included in a list 421 of news feeds of the “verification required” type, a message 422 may be displayed to indicate this. The list 421 of news feeds of the “verification required” type may include a news feed 423 corresponding to a notification message transmitted within a particular period. The news feeds 423 included in the list 421 of news feeds of the “verification required” type may be sorted in descending order of the time at which the notification message is transmitted.

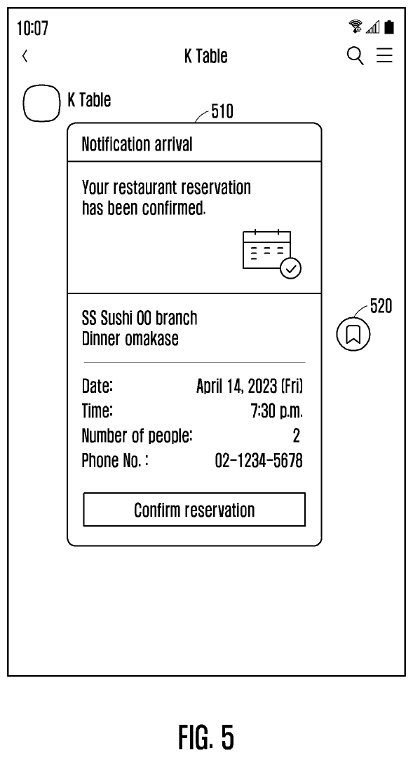

For example, referring to a screen 403 of FIG. 4C, an aggregation page 431 of a news feed may include a list 432 of news feeds of the “saved” type. The list 432 of news feeds of the “saved” type may include news feeds corresponding to notification messages stored by a user account. The stored notification messages may be notification messages that are requested to be stored or set by the user account. For example, referring to FIG. 5, a notification message 510 may be stored by an input that selects an interfacing object 520 to request to store the notification message 510 in a chatroom of a channel.

For example, referring to a screen 404 of FIG. 4D, an aggregation page 441 of a news feed may include a list 442 of news feeds of the “order/delivery” type. The list 442 of news feeds of the “order/delivery” type may include a news feed corresponding to a notification message of the progress type. The list 442 of news feeds of the “order/delivery” type may include a news feed corresponding to a notification message regarding an order or a shipment among the notification messages of the progress type. For example, the notification message of the progress type may be transmitted for a series of statuses including an order completion status, a product shipment status, an in-transit status, and a delivery completion status. A news feed corresponding to the notification message of the progress type may include status information 443 of the progress. The status information 443 of the progress may include information indicating a status 444 corresponding to a notification message among a series of predetermined statuses. Through the status information 443 of the progress, it may be identified which stage of the entire series of statuses the status 443 corresponding to the notification message corresponds to.

For example, referring to a screen 405 of FIG. 4E, an aggregation page 451 of a news feed may include a list 452 of news feeds of the “payment” type. The list 452 of news feeds of the “payment” type may include a news feed corresponding to a notification message of the cumulative aggregate type. The list 452 of news feeds of the “payment” type may include a news feed corresponding to a notification message regarding payment among notification messages of the cumulative aggregate type. For example, the news feed corresponding to the notification message of the cumulative aggregate type may include a credit card payment history 453 and information 454 on a cumulative aggregate of credit card usage amounts, when a credit card payment event occurs. For example, the information 454 on the cumulative aggregate of the credit card usage amounts may include information on a cumulative aggregate sum of credit card usage amounts for this month, information on an average expenditure for credit card usage amounts over 6 months, and information on a comparison between credit card usage amounts for this month and credit card usage amounts for last month.

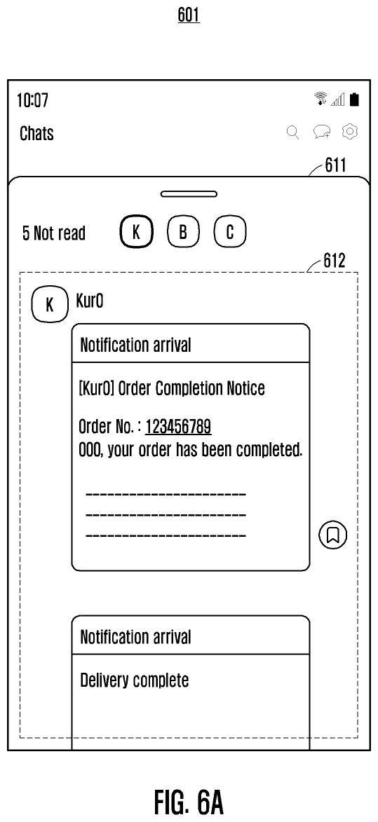

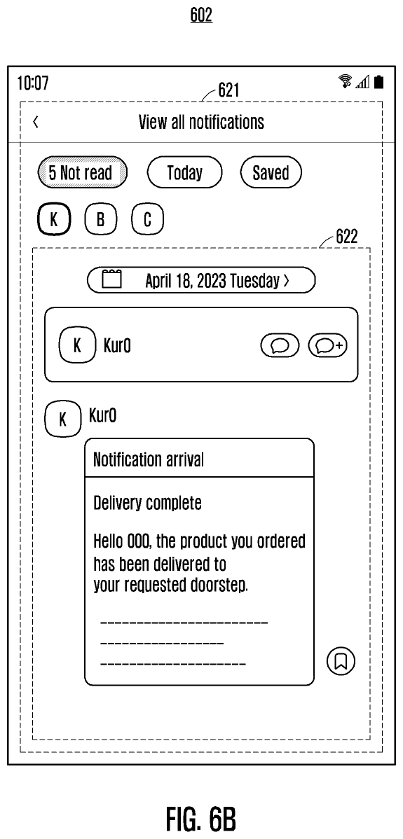

FIGS. 6A and 6B are diagrams illustrating a screen of a terminal displaying an aggregation page of a news feed according to an embodiment.

An aggregation page of a news feed may be provided to a terminal running an instant messenger linked to a server providing an IMS. The terminal may be the terminal 110 of FIG. 1. The terminal may include a terminal logged in with a user account subscribed to an IMS provided by the server. Hereinafter, the user account may be a user account logged into the terminal.

For example, the aggregation page of the news feed may include a list of news feeds aggregated by channel. The aggregation page of the news feed may include one or more lists of news feeds corresponding to each channel to which a notification message is transmitted. The list of each news feed may include one or more news feeds corresponding to a notification message of a particular channel.

For example, referring to a screen 601 of FIG. 6A, an aggregation page 611 of a news feed may include a list of news feeds by channel. The aggregation page 611 of the news feed may include a list 612 of news feeds of a first channel, a list of news feeds of a second channel, and a list of news feeds of a third channel. The list 612 of news feeds of the first channel may include a news feed corresponding to a notification message transmitted by the first channel. The news feed corresponding to the notification message may be the same as the notification message. For example, in the list 612 of news feeds of the first channel, the news feed corresponding to the notification message transmitted by the first channel may be sorted in ascending or descending order of the time at which the notification message is transmitted.

For example, in the list 612 of news feeds of the first channel, the news feed corresponding to the notification message transmitted by the first channel may be sorted in ascending or descending order of importance. For example, the list 612 of news feeds of the first channel may include a news feed corresponding to a notification message that has not been confirmed of receipt among the notification messages transmitted by the first channel.

For example, referring to a screen 602 of FIG. 6B, an aggregation page 621 of a news feed may include a list of news feeds by channel classified by type. The aggregation page 621 of the news feed may include a list of news feeds by channel classified into a “not read” type, “today” type, “saved” type, “order/delivery” type and “payment” type. A notification message that has not been confirmed of receipt may be classified as the “not read” type. A notification message related to the current time may be classified as the “today” type.

For example, a list 622 of news feeds included in the aggregation page 621 of news feeds may include a news feed corresponding to a notification message transmitted by the first channel among the notification messages that have not been confirmed of receipt. For example, in the list 622 of news feeds of the first channel, the news feed corresponding to the notification message transmitted by the first channel may be sorted in ascending or descending order of the time at which the notification message is transmitted. For example, in the list 622 of news feeds of the first channel, the news feed corresponding to the notification message transmitted by the first channel may be sorted in ascending or descending order of importance.

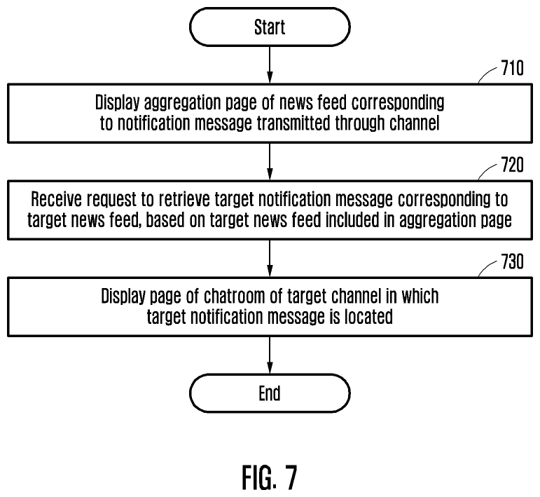

FIG. 7 is a flowchart of an operation of a terminal running an instant messenger according to an embodiment.

For example, the terminal may be the terminal 110 of FIG. 1. The terminal may include a terminal logged in with a user account subscribed to an IMS provided by the server.

Referring to FIG. 7, an operating method of the terminal according to an embodiment may include an operation 710 of displaying an aggregation page of a news feed corresponding to a notification message transmitted through a channel. The aggregation page may include news feed(s) corresponding to a notification message received by a user account logged in to the terminal. The aggregation page of the news feed may be a page provided through an instant messenger. An entry point in the instant messenger to access the aggregation page of the news feed is described below.

The operating method of the terminal according to an embodiment may include an operation 720 of receiving request to retrieve a target notification message corresponding to a target news feed, based on a target news feed included in an aggregation page. For example, the target news feed may be a news feed included in an aggregation page. For example, an input for selecting the target news feed may be an input for requesting to retrieve a target notification message corresponding to the target news feed.

The operating method of the terminal according to an embodiment may include an operation 730 of displaying a page of a chatroom of a target channel including the target notification message. When the request to retrieve the target notification message is received, the server may provide a page of the chatroom of the target channel where the target notification message may be viewed to the terminal of the user account. The terminal of the user account may access the page of the chatroom of the target channel through the news feed, where the target notification message is displayed in the chatroom of the target channel.

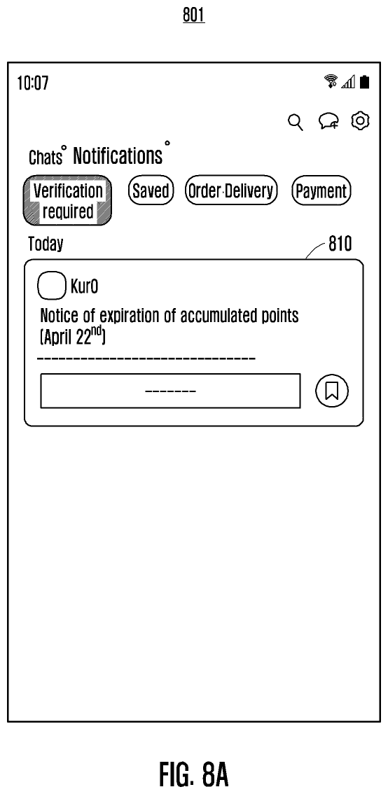

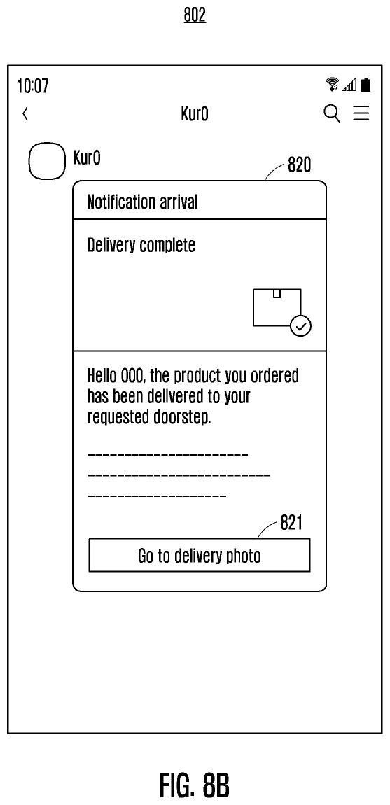

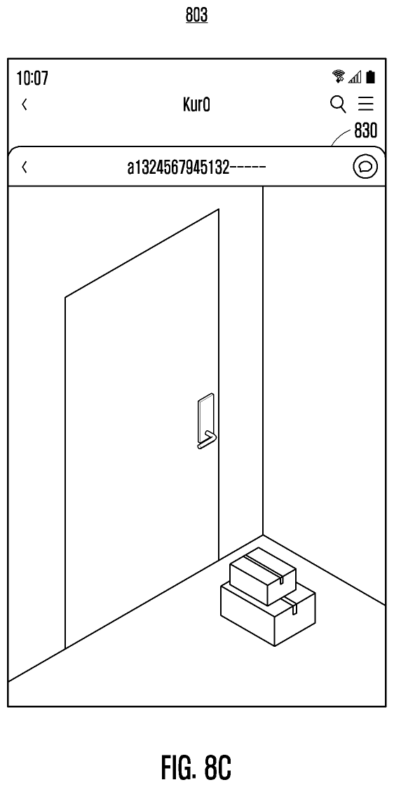

For example, referring to a screen 801 of FIG. 8A, an input for requesting to retrieve a target notification message corresponding to a target news feed may be transmitted to the server by an input for selecting a target news feed provided through an aggregation page or an area 810 where the target news feed is displayed.

When the request to retrieve the target notification message is made, a page of a chatroom of the target channel where the target notification message may be viewed may be provided in the terminal of the user account, as shown in a screen 802 of FIG. 8B. A target notification message 820 that is requested to be retrieved may be displayed on the page of the chatroom of the target channel.

A notification message may include an interfacing object regarding the notification message. For example, the target notification message 820 for notifying completion of delivery illustrated in FIG. 8B may include an interfacing object 821 that links to a page where a delivery completion image may be viewed. A page 830 including the delivery completion image may be displayed, as shown on a screen 803 of FIG. 8C, by an input for selecting the interfacing object 821. For example, the page 830 including the delivery completion image may be displayed as an upper layer of the page in the chatroom.

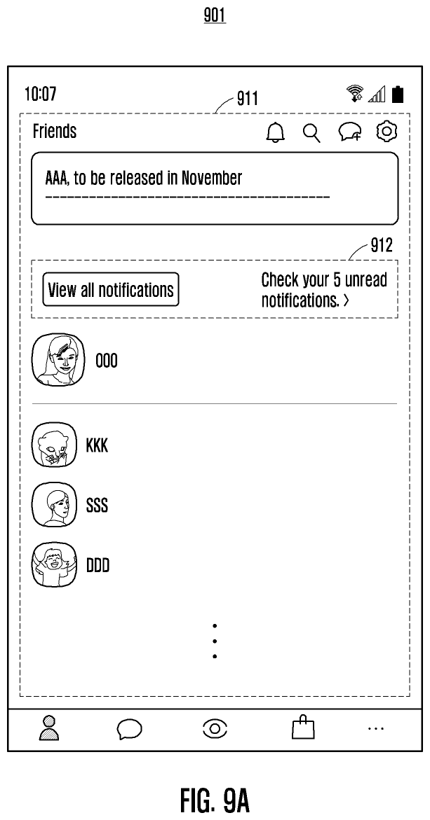

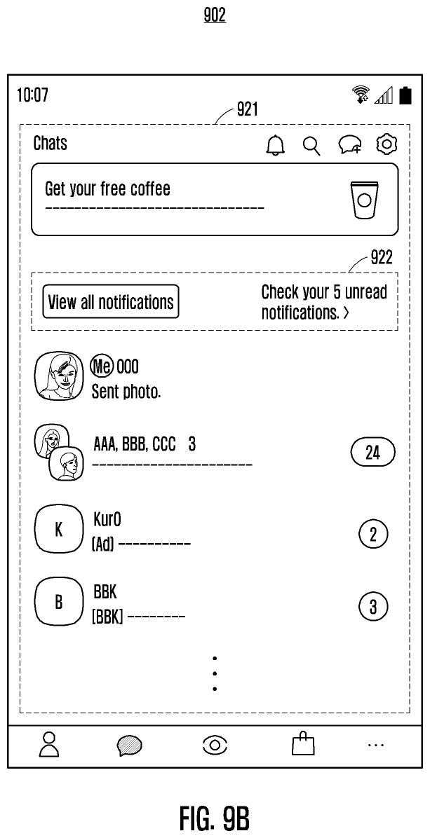

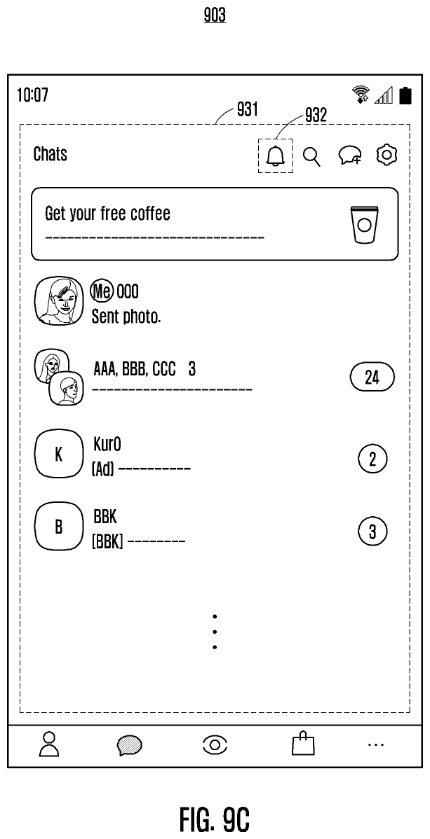

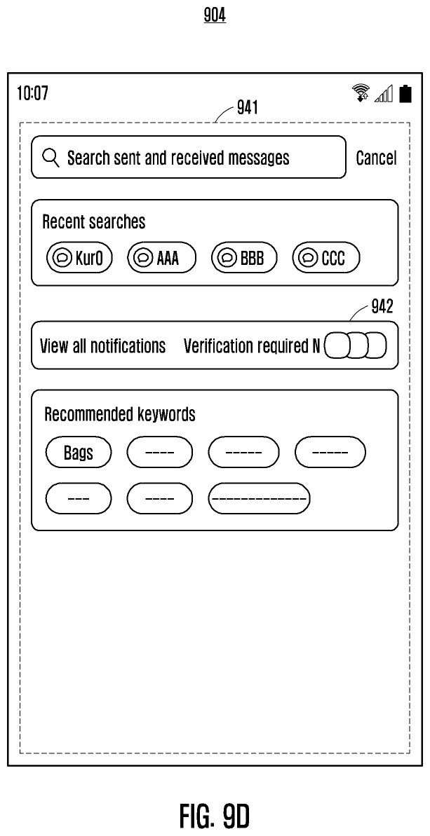

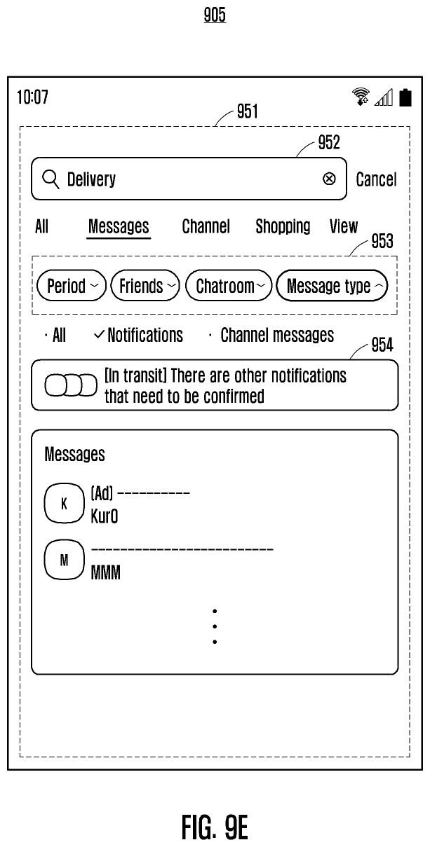

FIGS. 9A to 9E are diagrams illustrating entry points within an instant messenger for entering an aggregation page of a news feed according to an embodiment.

Referring to a screen 901 of FIG. 9A, a page 911 including a list of user accounts in a certain relationship (e.g., a friendship) in an instant messenger may include an interfacing object 912 for moving to an aggregation page of a news feed. When an input for selecting the interfacing object 912 is received, an aggregation page of the news feed may be provided to a terminal.

Referring to a screen 902 of FIG. 9B, a page 921 including a list of chatrooms in which messages are received in the instant messenger may include an interfacing object 922 for moving to an aggregation page of a news feed. When an input for selecting the interfacing object 922 is received, an aggregation page of the news feed may be provided to the terminal. Referring to a screen 903 of FIG. 9C, a page 931 including a list of chatrooms in which messages are received in the instant messenger may include an interfacing object 932 for moving to an aggregation page of a news feed. When an input for selecting the interfacing object 932 is received, an aggregation page of the news feed may be provided to the terminal.

Referring to a screen 904 of FIG. 9D, a search page 941 providing a search function for an IMS, such as another user account, chatroom, or message in the instant messenger, may include an interfacing object 942 for moving to an aggregation page of a news feed. When an input for selecting the interfacing object 942 is received, an aggregation page of the news feed may be provided to the terminal.

Referring to a screen 905 of FIG. 9E, when a search term (e.g., “delivery”) is input to a search box 952 of a search page 951, a search result corresponding to the input search term may be provided. The search page 951 may include a filter 953 for setting only a desired search result to be displayed. When the filter 953 is set to display only a search result related to a notification message, a notification message including the search term and/or a notification message of a type corresponding to the search term may be provided as the search result. The search result page 951 may include an interfacing object 954 for moving to an aggregation page of the news feed. When an input for selecting the interfacing object 954 is received, an aggregation page of the news feed may be provided to the terminal.

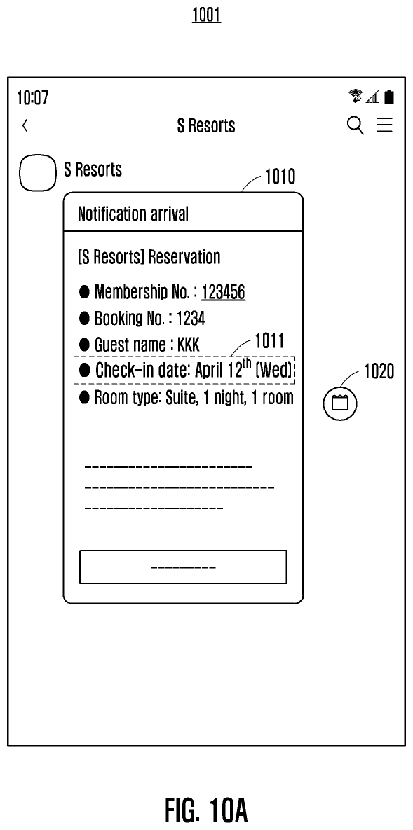

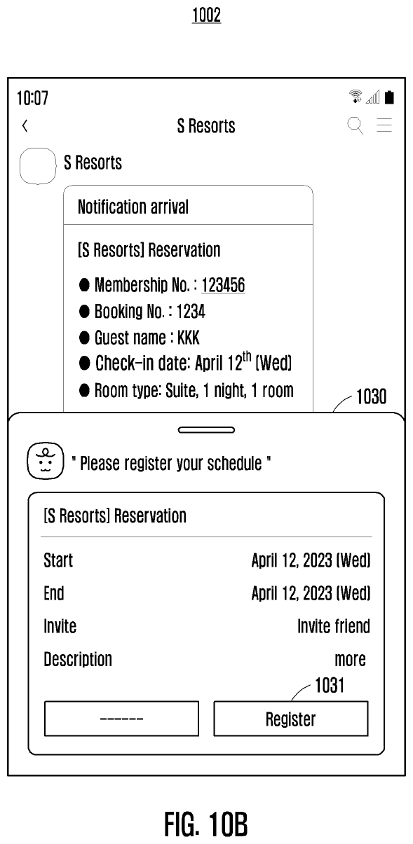

FIGS. 10A and 10B are diagrams illustrating a schedule generation function corresponding to a notification message according to an embodiment.

Referring to a screen 1001 of FIG. 10A, when a template of a notification message 1010 includes a field (e.g., a reservation time field, an expiration date field) related to a date, a schedule generation function corresponding to the notification message 1010 may be activated. For example, an interfacing object 1020 for requesting schedule generation corresponding to the notification message 1010 may be provided corresponding to the notification message 1010. A schedule management function for generating schedule information corresponding to the notification message 1010 may be called by an input for selecting the interfacing object 1020. For example, the schedule management function for generating schedule information corresponding to the notification message 1010 may be called by an input for selecting the notification message 1010. For example, the schedule management function for generating schedule information corresponding to the notification message 1010 may be called by an input for selecting a value 1011 of a field regarding a date.

Referring to a screen 1002 of FIG. 10B, when the schedule management function is called, a schedule management interface 1030 may be displayed in a partial area in a chat interface. The schedule management interface 1030 may provide a function for registering new schedule information and a function for retrieving and editing the registered schedule information. For example, the schedule management interface 1030 may automatically be input with information (e.g., the name of the schedule and the time of the schedule) on a new schedule based on information extracted from notification data. For example, a user may input the information (e.g., the name of the schedule and the time of the schedule) on the new schedule through the schedule management interface 1030. The user may request a server to generate the schedule through an input for selecting a “register” button 1031 of the schedule management interface 1030. The server may generate the requested schedule and register the generated schedule in a calendar under an account of the user.

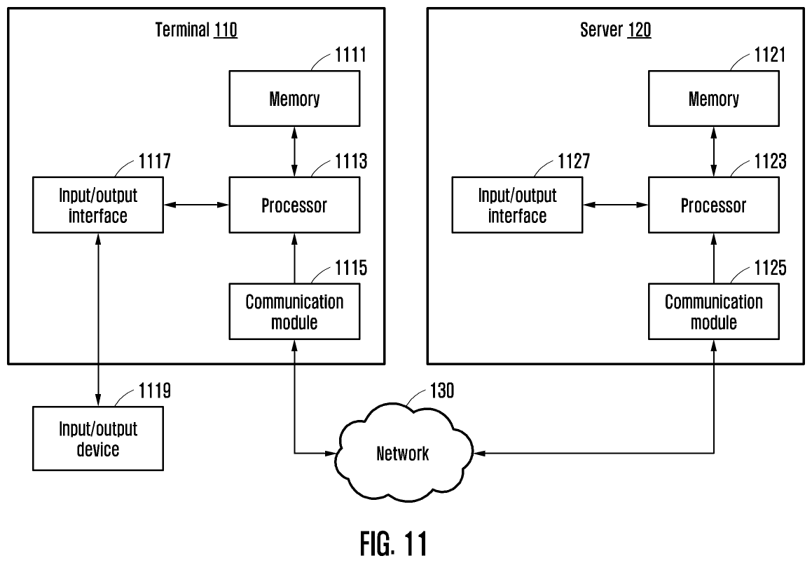

FIG. 11 is a diagram illustrating a hardware configuration of a system for the IMS according to an embodiment.

Referring to FIG. 11, a system (e.g., the system 100 of FIG. 1), according to an embodiment, may include the terminal 110 and the server 120 connected through the network 130.

The terminal 110 may be a mobile terminal implemented as a computer device. For example, the terminal 110 may communicate with the server 120 and/or other electronic devices through the network 130 by using a wired or wireless communication method.

The server 120 may be implemented as one or more computer devices providing commands, code, files, content, services, and the like by communicating with the terminal 110 and/or another server through the network 130. The communication scheme is not limited, and may include a communication scheme using a communications network (e.g., a mobile communication network, wired Internet, wireless Internet, and a broadcasting network) that may be included in the network 130 and a short-range wireless communication scheme between devices. For example, the network 130 may include one or more networks among networks, such as a personal area network (PAN), a local area network (LAN), a campus area network (CAN), a metropolitan area network (MAN), a wide area network (WAN), a broadband network (BBN), the Internet, and the like.

According to an embodiment, the server 120 may provide a file for installing an application to the terminal 110 accessing the server 120 through the network 130. In this case, the terminal 110 may install the application (e.g., an instant messenger) by using the file provided by the server 120. In addition, by control of an operating system (OS) and at least one program (e.g., a browser or an installed application) included in the terminal 110, the terminal 110 may access the server 120 and receive a service or content provided by the server 120. For example, when the terminal 110 transmits a service request message to the server 120 through the network 130 by control of the application, the server 120 may transmit code corresponding to the service request message to the terminal 110, and the terminal 110 may provide content to a user by composing and displaying a screen according to the code by control of the application.

According to an embodiment, the terminal 1010 and the server 1020 may respectively include memories 1111 and 1121, processors 1113 and 1123, communication modules 1115 and 1125, and input/output interfaces 1117 and 1127.

The processors 1113 and 1123 may perform at least one operation described above with reference to FIGS. 1 to 10B. For example, the processor 1113 may perform at least one operation to be performed in the instant messenger installed in the terminal 110 described above with reference to FIG. 7, and the processor 1123 may perform at least one operation related to the IMS described above with reference to FIG. 2. The processors 1113 and 1123 may be configured to process commands of a computer program by performing basic arithmetic, logic, and input/output operations. The commands may be provided to the processors 1113 and 1123 by the memories 1111 and 1121 or the communication modules 1115 and 1125.

The memories 1111 and 1121 may be a computer-readable storage medium, which may be volatile or non-volatile memory. The memories 1111 and 1121 may store information on the IMS described above with reference to FIGS. 1 to 10B. For example, the memory 1121 may store information on user accounts subscribed to an IMS, chatroom information, and notification message information.

The memory 1111 may include code for an instant messenger that is installed to be driven in the terminal 110 by files provided by the server 120 through the network 130.

The memory 1121 may store a program implementing operations for the IMS described above with reference to FIGS. 1 to 10B.

The communication modules 1115 and 1125 may provide a function for the terminal 110 and the server 120 to communicate with each other through the network 130 and a function for the terminal 110 and the server 120 to communicate with another electronic device or another server through the network 130.

For example, a request generated by the processor 1113 of the terminal 110 according to program code for an instant messenger stored in a storage medium, such as the memory 1111, may be transmitted to the server 120 through the network 130 by control of the communication module 1115.

For example, control signals, commands, content, files, and the like provided by control of the processor 1123 of the server 120 may be received by the terminal 110 through the communication module 1115 of the terminal 110 after passing through the communication module 1125 and the network 130.

The input/output interfaces 1117 and 1127 may be an interface for an input/output device 1119. For example, an input device may include a device, such as a keyboard or a mouse, and an output device may include a device, such as a display for displaying a communication session of an application. In another example, the input/output interface 1117 may be an interface for a device having input and output functions, such as a touch screen. Specifically, for example, when the processor 1113 of the terminal 110 processes commands of a computer program loaded in the memory 1111, content or a service screen composed by using data provided by the server 120 may be displayed on a display through the input/output interface 1117. An input received from a user through the input/output device 1119 may be provided in a form processable by the processor 1113 of the terminal 110 through the input/output interface 1117.

According to an embodiment, the terminal 110 and the server 120 may include other components that are not illustrated in FIG. 11. For example, the terminal 110 may be implemented to include at least a portion of the input/output device 1119 described above or may further include other components, such as transceivers, global positioning system (GPS) modules, cameras, various types of sensors, databases, and the like.

The embodiments described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion.

The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An operating method of a server providing an instant messaging service (IMS), the operating method comprising:
extracting information on a channel to which a notification message corresponding to a user account is transmitted;
determining a type of the notification message based on metadata of the notification message;
generating a news feed corresponding to the notification message based on the type of the notification message; and
providing an aggregation page of the news feed linked to a chatroom of the channel to a terminal of the user account.

2. The operating method of claim 1, wherein
the generating of the news feed corresponding to the notification message comprises:
determining a data type to be extracted for the generating of the news feed based on the type of the notification message;
extracting target data corresponding to the determined data type from the metadata of the notification message; and
generating the news feed including the target data.

3. The operating method of claim 1, wherein
the determining of the type of the notification message comprises
determining the type of the notification message based on metadata related to a template of the notification message.

4. The operating method of claim 1, wherein
the generating of the news feed corresponding to the notification message comprises
generating a news feed comprising status information of a progress corresponding to the notification message determined to be a progress type.

5. The operating method of claim 1, wherein
the generating of the news feed corresponding to the notification message comprises
generating a news feed comprising cumulative aggregate information of an item corresponding to the notification message determined to be a cumulative aggregate type.

6. The operating method of claim 1, further comprising:
providing a page of a chatroom of a channel comprising the notification message, based on a request to retrieve the notification message corresponding to the news feed.

7. The operating method of claim 1, wherein
the providing of the aggregation page of the news feed comprises
providing the aggregation page of the news feed based on whether the notification message has been confirmed of receipt.

8. The operating method of claim 1, wherein
the providing of the aggregation page of the news feed comprises
providing the aggregation page of the news feed based on whether the notification message has been stored.

9. The operating method of claim 1, wherein
the providing of the aggregation page of the news feed comprises
providing the aggregation page of the news feed based on an importance of the notification message.

10. The operating method of claim 1, further comprising
generating schedule information corresponding to metadata related to a schedule included in the notification message.

11. The operating method of claim 1, wherein
the news feed comprises information on the channel from which the notification message is transmitted.

12. The operating method of claim 1, wherein
the news feed comprises information on an interfacing object included in the notification message.

13. An operating method of a terminal running an instant messenger, the operating method comprising:
displaying an aggregation page of a news feed corresponding to a notification message transmitted through a channel;
receiving a request to retrieve a target notification message corresponding to a target news feed, based on the target news feed included in the aggregation page; and
displaying a page of a chatroom of a target channel including the target notification message.

14. The operating method of claim 13, wherein
the aggregation page of the news feed comprises
at least one of a list of news feeds aggregated by channel and a list of news feeds aggregated by type.

15. The operating method of claim 13, further comprising:
requesting generation of a schedule corresponding to the notification message; and
displaying a schedule generation page in which metadata extracted from the notification message is input as a parameter.

16. A non-transitory computer-readable storage medium storing instructions that, when executed by one or more processors, cause the one or more processors to perform the operating method of claim 1.

17. A server providing an instant messaging service (IMS), the server comprising one or more processors configured to:
extract information on a channel to which a notification message corresponding to a user account is transmitted;
determine a type of the notification message based on metadata of the notification message;
generate a news feed corresponding to the notification message based on the type of the notification message; and
provide an aggregation page of the news feed linked to a chatroom of the channel to a terminal of the user account.

18. The server of claim 17, wherein the one or more processors is configured to,
for the generating of the news feed corresponding to the notification message,
determine a data type to be extracted for the generating of the news feed based on the type of the notification message,
extract target data corresponding to the determined data type from the metadata of the notification message, and
generate the news feed including the target data.

19. The server of claim 17, wherein the one or more processors is configured to,
for the determining of the type of the notification message,
determine the type of the notification message based on metadata related to a template of the notification message.

20. A terminal running an instant messenger, the terminal comprising one or more processors configured to:
display an aggregation page of a news feed corresponding to a notification message transmitted through a channel;
receive a request to retrieve a target notification message corresponding to a target news feed, based on the target news feed included in the aggregation page; and
display a page of a chatroom of a target channel including the target notification message.
